(19) United States
(12) Patent Application Publication
(10) Pub. No.: US 2022/0256406 A1
(43) Pub. Date: Aug. 11, 2022

(54) SYSTEM AND METHOD FOR HANDOVERS IN AN OPTICAL WIRELESS COMMUNICATION NETWORK

(71) Applicant: SIGNIFY HOLDING B.V., EINDHOVEN (NL)

(72) Inventors: Andries VAN WAGENINGEN, WIJLRE (NL); Martinus Petrus CREUSEN, WIJLRE (NL); Joris Jan VREHEN, WAALRE (NL)

(21) Appl. No.: 17/628,590

(22) PCT Filed: Jul. 20, 2020
(86) PCT No.: PCT/EP2020/070403

§ 371 Date: Jan. 20, 2022

(30) Foreign Application Priority Data
Jul. 29, 2019 (EP) 19188809.8

(51) Int. Cl. H04W 36/00; H04B 10/116; H04B 10/114; H04B 10/077

(52) U.S. Cl. CPC H04W 36/0016; H04B 10/116; H04B 10/0775; H04W 36/0072; H04B 10/1149

(57) ABSTRACT

According to one aspect disclosed herein, there is provided a system (500) comprising at least two light cells (504, 508) connected to form a light communication network. The system comprises at least two light cells each formed by a respective first beam of light comprising a respective data signal and a second beam of light comprising a pilot signal. Each data signal has an amplitude profile with a portion above a pre-determined threshold level (316), and said portion of the respective data signals of the at least two light cells partially overlap to form an overlapping region (306) with an amplitude profile (720, 730) above the predetermined threshold level. Each pilot signal in turn has an amplitude profile (740, 750) which comprises an ascending edge and a descending edge and a footprint which is aligned with a footprint of the respective data signal for use in performing a pre-handover and/or handover.

### TECHNICAL FIELD

The present disclosure relates to handovers in optical wireless communication networks and systems and method for performing them.

### BACKGROUND

Light Fidelity (LiFi) refers to techniques whereby information is communicated in the form of a signal embedded in visible light, infrared light or ultraviolet light emitted by a light source. Such techniques are sometimes also referred to as coded light, visible light communication (VLC) or free-space optical communication (FSO). The signal is embedded by modulating a property of the light, typically the intensity, according to any of a variety of suitable modulation techniques. For communication at high speed, often Infrared (IR) rather than visible light communication is used. Although the ultraviolet and infrared radiation is not visible to the human eye, the technology for utilizing these regions of the spectra is the same, although variations may occur as a result of wavelength dependencies, such as in the case of refractive indices. In many instances there are advantages to using ultraviolet and/or infrared as these frequency ranges are not visible to the human eye. Ultraviolet quanta have higher energy levels compared to those of infrared and/or visible light, which in turn may render use of ultraviolet light undesirable in certain circumstances.

Based on the modulations, the information in the LiFi coded light can be detected using any suitable light sensor. For example, the light sensor may be a photodiode. The light sensor may be a dedicated photocell (point detector), an array of photocells possibly with a lens, reflector, diffuser or phosphor converter (for lower speeds), or an array of photocells (pixels) and a lens for forming an image on the array. E.g., the light sensor may be a dedicated photocell included in a dongle which plugs into a user device such as a smartphone, tablet or laptop, or the sensor may be integrated and or dual-purpose, such as an array of infrared detectors initially designed for 3D face recognition. Either way this may enable an application running on the user device to receive data via the light.

For instance, this enables that a sequence of data symbols may be modulated into the light emitted by a light source, such as light emitting diodes (LEDs) and laser diodes (LDs), faster than the persistence of the human eye. Contrary to radio frequency (RF) communication, LiFi generally uses a line-of-sight connection between the transmitter and the receiver for best performance.

LiFi is often used to embed a signal in the light emitted by an illumination source such as an everyday luminaire, e.g. room lighting or outdoor lighting, thus allowing use of the illumination from the luminaires as a carrier of information. The light may thus comprise both a visible illumination contribution for illuminating a target environment such as a room (typically the primary purpose of the light), and an embedded signal for providing information into the environment (typically considered a secondary function of the light). In such cases, the modulation may typically be performed at a high enough frequency to be beyond human perception, or at least such that any visible temporal light artefacts (e.g. flicker and/or strobe artefacts) are weak enough and at sufficiently high frequencies not to be noticeable or at least to be tolerable to humans. Thus, the embedded signal does not affect the primary illumination function, i.e., so the user only perceives the overall illumination and not the effect of the data being modulated into that illumination.

Wireless optical networks, such as LiFi networks, enable electronic devices like laptops, tablets, and smartphones to connect wirelessly to the internet. Wi-Fi achieves this using radio frequencies, but LiFi achieves this using the light spectrum which can enable unprecedented data transfer speed and bandwidth. WiFi systems are becoming more limited in bandwidth due to interference resulting from neighboring systems and their omnidirectional radiation pattern. WiFi signals can pass through walls, ceilings, doors etc. but their bandwidth reduces with the density and number of units that are used. LiFi is becoming more and more popular as LED lighting systems are used in place of conventional lighting systems. Contrary to WiFi, LiFi is directional and shielded by light blocking materials, which provides it with the potential to support higher bandwidth communication in a dense area of users as compared to WiFi.

Furthermore, LiFi can be used in areas susceptible to electromagnetic interference. Consider that wireless data is now often required for more than just traditional connected devices—today televisions, speakers, headphones, printer's, virtual reality (VR) goggles and even refrigerators use wireless data to connect and perform essential communications.

Digital wireless communications networks (optical or radio frequency based) are typically formed from a number of transmitter nodes or access points, modems, and transceivers. The transmitter nodes each sit in the center of an area typically referred to as a cell. This arrangement may also be referred to overall as an access point. The cell is the area within which the transmissions from the node may be picked up by a receiver. When positioned next to each other the cells typically fit together to cover larger areas. Each node may be connected to a respective modem. The modem processes outgoing data signals into waveforms or modulated light suitable for transmission via wireless or optical channels respectively. Correspondingly, the modem may process incoming wirelessly received modulated light or waveforms into data.

When a client device moves from the coverage area of one cell to the coverage area of another cell, a handover is needed. That is to say, when a receiver (such as a user device, a client device, a mobile phone, etc.), moves from the current cell to the neighboring cell, then any active communication must be handed over to the node or access point of that neighboring cell. Such a handover is typically performed when the client device determines that signals received from the neighboring cell are stronger than those of the current cell. Alternatively, the base station may detect that a handover is needed based on incoming signals from the client device in the reverse uplink. The handover thus occurs when the amplitude of the transmissions from the current cell drops to a lower level, typically furthest from the node in the center of the cell. Handovers are intended to be made as quickly as possible in order to minimize disruption to any ongoing communication or data transfers, and may include a preparation period in order to facilitate this. The design of optics of LiFi access points can support seamless handovers. It should be understood that the referred to receiver device may also comprise the necessary technology to transmit data signals. For example, the receiver device may be able to transmit data signals to one or more transmitter nodes, which may comprise the necessary technology to receive those data signals. The terms ‘receiver’ and ‘transmitter’ are used herein to distinguish the respective devices for the purposes of explaining the invention, and not to limit the respective devices to only one of transmitting or receiving functionalities.

FIG. 1 and FIG. 2 illustrate a LiFi receiver 112 moving from the coverage area of a first LiFi access point to a second LiFi access point.

FIG. 1 shows a side view of a system 100 comprising two LiFi access points, each comprising a transmitter node 103, 107 and an output light transmission 104, 108 forming a surrounding light cell. A first LiFi node 103 on the left-hand side emits a first beam of light 104 comprising a first signal and provides the first access point 102, and a second LiFi node 107 on the right-hand side emits a beam of light 108 comprising a second signal and provides the second access point 106. The light cell of LiFi access point 102 and the light cell of LiFi access point 106 (formed by the respective beams of light) overlap in a central area 110. It is in this area 110 where the handover from one access point to the other access point typically occurs. In FIG. 1 the receiver device 112 is shown located within the reception area or light cell of the first access point 102, with a direction of movement toward the coverage area or light cell of the second access point 106 by arrow 114.

FIG. 2 shows a plan view of the same system 100 as in FIG. 1. The system 100 comprises two beams of light output radially from respective access points to form surrounding light cells 104, and 108. In FIG. 2 the transmitter nodes themselves have not been shown. When shown as though viewed from above, the light cells formed by each node are circular in shape. It should be understood that this circular shape is an idealized form of the light cell and the area in which the emitted signal may be received. Similarly to in FIG. 1, the overlapping region 110 represents the area in which the signals from both access points may be received by a receiver 112. The amplitude of the emitted signal may vary with location within each of the light cells. In FIG. 2 the receiver device 112 is shown located within the overlapping region, e.g. within the light cell of the first access point 102, and the second access point 106. The receiver 112 has a direction of movement toward the center of the coverage area or light cell of the second access point 106 illustrated by arrow 114. This direction of movement causes the receiver device to traverse the overlapping region 110 and will result in a handover process from the first access point 102 to the second access point 106.

It should be understood that the LiFi access points or APs are access points to a LiFi network or optical wireless communications network. Each access point has a certain coverage area and provides optical access for receiver devices within this coverage area to enable data transfer. The receiver device may be for example, a mobile device such as a smartphone, mobile phone, tablet, laptop computer, or dongle for connecting to any of these devices for the purposes of receiving digital information in the form of coded light or optical signals. That is, a device or dongle capable of providing optical access to a LiFi access point for data transfer.

FIG. 3 shows a typical system and its specific arrangements for performing handovers between access points. The figure shows two aspects of the light cells. The first is a plan view of the two access points and the coverage area of the light cells formed by their respective emitted beams of light. Below the plan view is a cross sectional view taken along the line 300 on the plan view. The cross section shows the received signal amplitude of the respective data signals of the access points. This cross section view thus shows the amplitude profile of the data signal distribution for each light cell. In FIG. 3 it is intended that the shape of the profile shown represents the signal attenuation experienced as a result of the inverse square law. The inverse square law states that a specified physical quantity or intensity (for example the intensity of light or electromagnetic radiation) is inversely proportional to the square of the distance from the source of that physical quantity. The fundamental cause for this can be understood as geometric dilution corresponding to point-source radiation into three-dimensional space.

Typically a handover between a first access point 102 and a second access point 106 will have a number of trigger conditions which, when detected, cause the performance of certain processes of the handover. For example, when the receiver device is connected to the first access point 102, the detection of another data signal from a second access point 106 (e.g. by the receiver entering the light cell of the other access point), may trigger a preparation process for an anticipated handover to the second access point 106 emitting the detected data signal. This preparation allows for the handover to be executed as quickly as possible. The signal amplitude may have to exceed a threshold minimum amplitude before the detection of the another data signal from the second access point condition is considered fulfilled. This minimum threshold is represented in FIG. 3 by the lower horizontal dotted line 310.

The data signal distribution of each of the data signals output by the first and second access points have a signal amplitude profile approximately represented in FIG. 3 by the lines 302 and 304 respectively (resulting from the inverse square law). If a receiver is moving from left to right along the line 300, the signal amplitude it experiences is that of the profile shown in the cross sectional view. As the receiver moves from left to right the first condition described above is detected upon reaching the second vertical dotted line 308. This dotted line 308 also marks an edge of the overlapping region between the two light cells. Detecting this condition or edge can be used to trigger the preparation of a handover between the two access points.

As the receiver continues to move from left to right the receiver reaches a crossing point 312 where the ascending edge of one signal 302 crosses the descending edge of another signal 304. That is to say, this is when the amplitude of both data signals received from the two access points are equal. After this crossing point 312 the amplitude of the data signal of the second access point exceeds the amplitude of the data signal of the first access point and the execution of the handover is triggered. This condition, where the amplitude of the data signal of the first access point decreases and the amplitude of the data signal of the second access point increases, takes place over the second half of the overlapping region. It is in this region that the handover is executed. The handover needs to happen within this second half as the handover must have been completed before the receiver moves outside of the coverage area of the first access point.

As the receiver continues to move from left to right along cross section line 300 the data signal of the first access point 102 is no longer detected and only the data signal of the second access point is received at the receiver. At least the signal strength or amplitude of the data signal of the second access point drops below a minimum threshold 310. This edge of the overlapping region is marked in FIG. 3 by vertical dotted line 314.

In FIG. 3 each access point emits light with a signal strength or amplitude distribution with a gradual slope. That is a slope which declines with a shallow gradient in an outward radial direction. This arrangement provides a long period of time for a receiver device moving between the light cells to detect a decrease of signal of the first access point and an increase in amplitude of the signal of the second access point. This enables the receiver to trigger the system to anticipate the handover, even if the signal amplitude of the data signal of the first access point is still larger than that of the second access point. It also provides the system enough time to execute the handover after it is detected that the data signal amplitude of the second access point has become stronger than that of the first access point.

### SUMMARY

However, there is a problem with this system. The signal strength or amplitude of the data signals of both access points is relatively low (this is below a desired threshold which allows an optimal level of performance denoted by horizontal dashed line 316) within the overlapping region. Thus the performance of the communication link is sub-optimal in the overlapping area where only one of the two access points can be connected to at any one time. Therefore although the system of FIG. 3 allows for a long period of time in which to perform the handover (and thus it is less likely that the handover will fail due to moving out of the overlapping region before completion), the performance during this extended period of time for handover is reduced to a level which detrimentally effects the quality of the data transfer.

FIG. 4 shows a similar system to that of FIG. 3. However, in FIG. 4 the amplitude profile 402, 404 of the signal distribution has steep sloping edges with a flat central region. That is to say the gradient of the edges is highly positive or highly negative, whereas in comparison the central region approximates to a plateau. As a result of this data signal distribution, within the overlapping region 306 the amplitude of at least one of the two signals is always above the desired performance threshold (indicated in FIG. 4 by the dashed line 316). Therefore because the signal strength of both access points is above the threshold 316 in the overlapping area, the performance of the communication link is optimal in the overlapping area. There is not a crossing point as for the system of FIG. 3, but instead two crossing lines which overlap at the same amplitude. There is also a large amount of time for preparation of the handover upon detection of the data signal of the second access point.

However, when a receiver moves from left to right along the line 300, that is when the receiver moves from the light cell of the first access point to the light cell of the second access point, the trigger for the execution of the handover occurs at a later point during crossing the overlapping region. The trigger is when the detected data signal of the second access point becomes stronger than that of the first access point. This is because the data signals of both access points are equal in a large part of the overlapping area, and when they begin to differ from each other the steep slope means that this difference occurs quickly in comparison to the whole width of the overlapping region. Thus the handover is in danger of not being completed before the data signal of the first access point is lost altogether. This arrangement therefore has the negative effect of drastically limiting the time for the system to execute handover and will often lead to an interruption of the data transfer or communication.

The system needs time to prepare and execute the handover. During this time, the receiver needs to maintain a connection with the first access point until the connection with the second access point is established. Although the first system of FIG. 3 benefits from a good amount of time in which to prepare for and then to execute a handover within the overlapping region, the signal amplitude of the first light cell falls to a low level by the time the handover is triggered, inhibiting the performance during the handover and possibly causing the handover to fail.

If a receiver moves from the coverage area of the first access point to that of the second access point, a decision criterion is needed to execute the handover process. The decision is based on the detection that the received signal of the second access point is stronger or has a higher amplitude than that of the first access point. Thus, although the second system of FIG. 4 maintains a good signal amplitude within the overlapping region and thus maintains a good performance (above the level 316) during handover and preparation, the proportion of the overlapping region in which the handover must be executed is very small. Thus the handover is likely to fail to be completed in time, interrupting the data transmission.

The inventors have therefore realized that there is a need to provide a system which achieves both a good performance level during the handover, but also to provide enough time for executing the handover. This goal is achieved by a system as claimed in claim 1, a transmitter node as claimed in claim 9 and a method as claimed in claim 10.

One way to do this is by providing a system comprising at least two light cells. The light cells are each formed by beams of light having a signal distribution with an amplitude profile comprising an ascending edge, a plateau, and a descending edge. The light cells overlap to form an overlapping region with at least one edge where one of the two data signals has an amplitude of the plateau, and a crossing point where the ascending edge of one signal crosses the descending edge of the other signal. At the crossing point the data signal should be above the desired performance threshold. That is to say, the data signal plateaus out in the overlapping region such that at the edge of the overlapping region the amplitude is at the height of the plateau.

Here the signal amplitude represents the signal amplitude/strength in the coverage area as received by the receiver devices. At which specific height the signal amplitude would need to be considered, depends on where receiver devices may be expected. This may differ per application. In case of a smartphone, mobile phone or tablet communicating this will corresponds to the height where mobile devices are generally carried, for example within the range of 0.75-1.5 meter. This roughly corresponds with the height at which stationary devices on desks are commonly used. In such scenario, one should consider the signal amplitude/strength at a height of 1.0 or 1.25 meters above the floor-level.

In an industrial application where receivers are mounted on top of vehicles, for example in a warehousing setting, the height at which we need to consider the signal amplitude/strength could be higher. This however does not detract from the concepts presented herein which considers the amplitude profile at a pre-determined height where receivers are expected.

A first embodiment of the present invention achieves this is by using a pilot signal as well as a data signal. The pilot signal having an ascending and a descending edge, and providing the trigger criteria for the preparation and execution of the handover, while the data signal has a large plateau and steep edges which provides the data transfer and thus maintains the performance level within the overlapping region.

Disclosed herein, there is provided a system comprising at least two light cells, the light cells connected to form a light communication network where each light cell provides an access point of the light communication network, the system comprising: at least two light cells each formed by emitted beams of light comprising a signal, where the signal distribution has an amplitude profile which comprises an ascending slope, a plateau, and a descending slope, the at least two light cells overlapping to form an overlapping region with at least one edge where one of the two signals has an amplitude of the plateau whilst overlapping with the other of the two signals, and a crossing point where the ascending slope of one signal crosses the descending slope of the other signal, thereby enabling triggering of a handover process of a receiver device from one light cell to the other light cell in response to being detected by a receiver device.

The light cell may also be referred to as an optical wireless communication cell. The light cell is a coverage area of the optical wireless data signal as produced by a transmitted node of the system. The emitted beam of light from the transmitter node forms the light cell, and thus the emitted beam and node together provide an access point to the communication network.

Preferably, the system comprising: the receiver device configured to detect at least two signals in the form of emitted beams of light, the at least two signals indicating that the receiver device is located within at least two respective light cells which provide at least two access points of a light communication network, and upon detection of the edge of the overlapping region, or the crossing point of the overlapping region, trigger a pre-handover process or a handover process respectively.

The receiver may also, upon detection of an increase in amplitude of the signal of one light cell and the decrease in amplitude of the signal of another light cell trigger a pre-handover process.

Preferably, the beam of light is emitted through an optical element comprising one or more of a freeform optical element, a lens optical element, and a reflector optical element.

Preferably, the source of the beam of light is a single LED or an array of LEDs.

Preferably, the source of the beam of light is a single LED behind a single freeform optical element or an array of LEDs behind a single freeform optical element.

Preferably, the signals of the at least two light cells are differentiable from each other.

Optionally, the signals are differentiable from each other by each signal of each light cell having a different signal wavelength.

Optionally, the signals are differentiable from each other by each signal of each light cell having a different signal modulation frequency.

Optionally, the signals are differentiable from each other by each signal of each light cell having a different symbol in the pre-amble of the data signal, or a different LiFi identifier.

Also disclosed is a method of performing at a receiver device a handover between at least two light cells each comprising a signal, the light cells connected to form a light communication network where each light cell provides an access point of the light communication network, the method comprising: detecting an edge of an overlapping region of the at least two light cells, or detecting a crossing point in an overlapping region of the at least two light cells where an ascending slope of the signal of one light cell crosses a descending slope of the signal of the other light cell; in response to said detecting the edge, performing a pre-handover process in anticipation of the receiver device moving from one light cell to the other light cell; and

in response to said detecting the crossing point, triggering a handover process of the receiver device from one light cell to the other light cell.

According to a first aspect disclosed herein, there is provided a system comprising at least two light cells, the light cells connected to form a light communication network where each light cell provides an access point of the light communication network, wherein the system comprises: at least two light cells each formed by a respective first beam of light comprising a respective data signal and a second beam of light comprising a pilot signal, where each data signal has an amplitude profile at a predetermined height with a portion above a pre-determined threshold level, and said portion of the respective data signals of the at least two light cells partially overlap to form an overlapping region with an amplitude profile above the pre-determined threshold level, where each pilot signal has an amplitude profile at the predetermined height which comprises an ascending edge and a descending edge and a footprint which is aligned with a footprint of the respective data signal, the respective pilot signals of the at least two light cells overlapping to form an overlapping region with an amplitude profile which comprises an ascending edge comprising the ascending edge of one pilot signal and a descending edge comprising the descending edge of the other pilot signal and with a footprint which is aligned with a footprint of the of the overlapping region of the data signals and a crossing point where the ascending edge of one pilot signal crosses the descending edge of the other pilot signal.

As discussed herein above the predetermined height is based on the communication application requirements; which for facilitating handheld mobile communication might be in the range of 0.75-1.5 meter and thus in embodiments may be set at for example 1.1 meter.

The amplitude profiles have the above relationship (relative shapes) in at least one vertical cross-section. Optionally, the horizontal (plan view) footprint of each cell may be circular (i.e. the profiles have the above relationship in any vertical cross-section).

In embodiments, the amplitude profile of the respective data signals and the overlapping region of the data signals provides a combined data signal amplitude profile which is above the pre-determined threshold level at all locations within the overlapping region of the two data signals.

In embodiments, the system comprising: a receiver device configured to detect one or more data signals in the form of emitted beams of light and at least two pilot signals, the at least two pilot signals indicating that the receiver device is located in a proximity of at least two respective light cells which provide at least two access points of a light communication network, and upon detection of an edge of the pilot signal overlapping region, or the crossing point of the pilot signal overlapping region, trigger a pre-handover process or a handover process respectively.

In embodiments, the pilot signal is a lower frequency signal than the data signal.

In embodiments, the data signal has a frequency above two megahertz, and/or the pilot signal has a frequency below two megahertz.

In embodiments, the pilot signal footprint may extend beyond the data signal footprint such that the light cell for data transfer is smaller than the coverage area of the pilot signal. Further, the pilot signal may have a footprint which is aligned centrally with the footprint of the data signal, but which may not align at the edges.

In embodiments, the pilot signals of the at least two light cells are differentiable from each other.

In embodiments, the pilot signals of the at least two light cells are differentiable from each other by one or more of a different signal wavelength, a different signal modulation frequency, a different symbol in a pre-amble of the signal, or a different LiFi identifier.

In embodiments, the beam of light providing the pilot signal and/or the data signal is emitted through one or more optical elements comprising a freeform optical element, a lens optical element, or a reflector optical element.

In embodiments, the source of the beam of light providing the pilot signal and/or the data signal is a single LED or an array of LEDs.

According to a second aspect disclosed herein, there is provided a transmitter node for use in an optical wireless communication network, the transmitter node configured to emit a beam of light comprising a pilot signal and another beam of light comprising a data signal, the beams of light forming a light cell where the light cell provides an access point of the optical wireless communication network, where the pilot signal has an amplitude profile at a predetermined height which comprises an ascending edge and a descending edge and a footprint which is aligned with a footprint of the data signal, and where the data signal has an amplitude profile at the predetermined height above a pre-determined threshold level.

According to a third aspect disclosed herein, there is provided a method of performing at a receiver device a handover between at least two light cells comprising a pilot signal and a data signal, the light cells connected to form an optical wireless communication network where each light cell provides an access point of the optical wireless communication network, the method comprising: detecting an edge of an overlapping region of the at least two pilot signals of the light cells, or detecting a crossing point of an overlapping region of the at least two pilot signals of the light cells where the ascending slope of the pilot signal of one light cell crosses the descending slope of the pilot signal of the other light cell; in response to said detecting the edge, performing a pre-handover process in anticipation of the receiver device moving from one light cell to the other light cell; and in response to said detecting the crossing point, triggering a handover process of the receiver device where the receiver device transfers from the data signal of one light cell to the data signal of the other light cell.

### BRIEF DESCRIPTION OF THE DRAWINGS

To assist understanding of the present disclosure and to show how embodiments may be put into effect, reference is made by way of example to the accompanying drawings in which:

FIG. 1 shows a side view of a system 100 comprising two LiFi access points (showing their amplitude profiles perpendicular to the plane of the ceiling);

FIG. 2 shows a plan view of a system 100 comprising two LiFi access points (showing their footprints in the plane of the ceiling);

FIG. 3 shows a plan view of two access points and the coverage area of the light cells formed by their respective emitted beams of light, and a cross sectional view of the received signal amplitude of the respective data signals of the access points;

FIG. 4 shows a plan view of two access points and the coverage area of the light cells formed by their respective emitted beams of light, and a cross sectional view of the received signal amplitude of the respective data signals of the access points;

FIG. 5 shows a schematic diagram of the optical wireless communication system 500;

FIG. 6 shows a plan view of two access points and the coverage area of the light cells formed by their respective emitted beams of light, and a cross sectional view of the received signal amplitude of the respective data signals of the access points; and

FIG. 7 shows a plan view of two access points and the coverage area of the light cells formed by their respective emitted beams of light, and a cross sectional view of the received signal amplitude of the respective pilot signal and data signals of the access points.

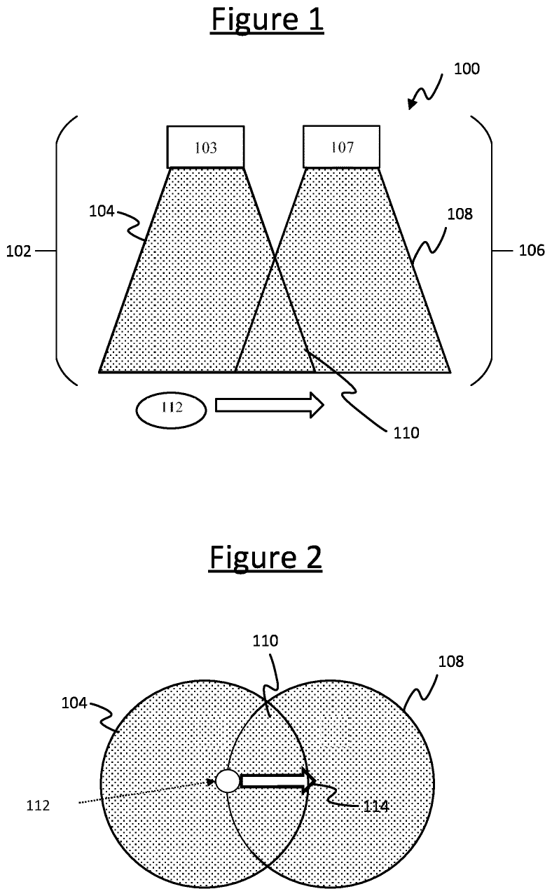

### DETAILED DESCRIPTION OF EMBODIMENTS

A LiFi network with multiple LiFi access points needs to handover a LiFi receiver when the receiver moves from the coverage area of one LiFi access point to a neighboring LiFi access point. To enable a seamless handover, the LiFi access points apply a dedicated optical signal distribution. This signal distribution has an amplitude profile such that it, in response to the receiver's movements, triggers the LiFi system to anticipate and prepare, and to execute the handover, while maintaining the connection with the LiFi network and a good performance of the connection.

The systems of the present invention are designed such that the following condition are met.

Data signal—The strength of the data signal received at either receiver (i.e. downlink connection) or access point (i.e. uplink connection) depends on several factors: transmitted signal strength, the transfer characteristics of the link, and the receiver transfer function. The transmitted signal strength is the strength of the signal transmitted from the transmitter. The transfer characteristics comprise features which effect the transfer path, e.g. the distance between transmitter and receiver, the angular distribution of the source signal, and any blocking or absorbing media in between the transmitter and receiver, etc. The receiver transfer function is the sensitivity e.g. of a photodiode vs the frequency of the signal.

Handover timing—The system needs time to prepare and execute the handover. During this time, it needs to maintain the connection with the first LiFi access point until the connection with the second LiFi access point is established. For this purpose, the received signal of the first LiFi access point should stay above a first level (dashed line 310).

Decision criterion—If a LiFi receiver moves from the coverage area of the first LiFi access point to that of the second LiFi access point, a decision criterion is needed to execute the handover process. The decision is based on the detection that the received signal of the second LiFi access point is stronger or has a higher amplitude than that of the first LiFi access point.

Performance—During the time that the LiFi receiver moves within the overlapping region and coverage area of both the first LiFi access point and the second LiFi access point, the performance should be maintained by keeping the emitted signal amplitude receiver by the receiver above a second level (dashed line 316).

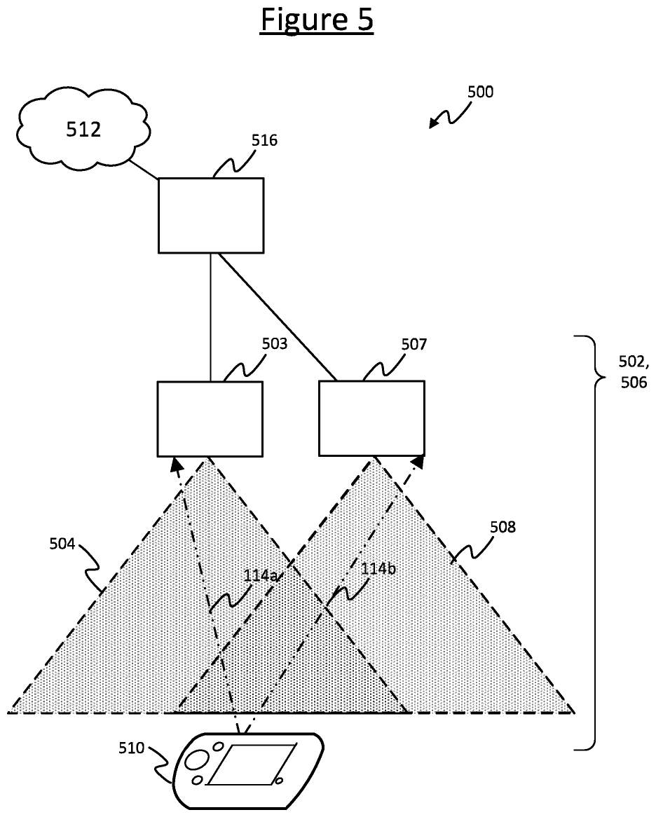

FIG. 5 shows a schematic diagram of the optical wireless communication system 500. The system comprises at least two access points 502, 506. Each access point comprises a light cell 504, 508, and a transmitter node 503, 507. Each of the transmitter nodes 503, 507 are configured to provide the functions of forming a light cell by emitting a beam of light to transmit data to a receiver device 510. The transmitter nodes 503, 507 are connected to controller 516. The controller 516 is coupled to at least two transmitter nodes 503, 507. Each transmitter node 503, 507 may also be connected to a network 112, and also via a feedback signal 514a, 514b to the receiver device 510.

The receiver device 510 can be any of the above mentioned devices which are capable of receiving data transmitted by optical wireless transmission methods. For example, it may be an electronic device such as a laptop, tablet, smartphone, smart sensor (e.g. CO2 sensor), television, speaker, headphones, printer, or even a kitchen appliance such as a refrigerator. It should be understood that any receiver device which comprises the appropriate light sensor is capable of receiving data via the present system. That is, any suitable light sensor able to convert incident beams of light into a data signal for processing. The light sensor may be a dedicated photocell (point detector), or a camera comprising an array of photocells (pixels) and a lens for forming an image on the array. E.g. the camera may be a general purpose camera of a mobile user device such as a smartphone or tablet. Camera based detection of LiFi signals is possible with either a global-shutter camera or a rolling-shutter camera. The light sensor may be a dedicated photocell (point detector), or a camera included in a dongle which plugs into a receiver device such as a smartphone, tablet or laptop. This enables the receiver device to receive data via the beam of light.

The controller 516 is operatively coupled to the at least two transmitter nodes 503, and 507, and is configured to provide data to the transmitter nodes 530 and 507 for emitting as an optical wireless data signal. The controller 516 may also receive feedback signals 514a, 514b from a receiver device 510. The feedback signals may be receiver at the controller via respective transmitter nodes 503, 507. The controller 516 may, as result of such feedback signals, control the handover of the receiver device from one transmitter node 503 to another transmitter node 507, and hence from one light cell 504 to another light cell 508.

In embodiments the controller 516 may be distributed and located partially within each of the transmitter nodes 503, 507 of the system 500, thus forming part of the transmitter node apparatus. FIG. 5 shows an example of a wireless optical data transmission system 500 comprising a plurality of transmitter nodes 503, 507. Each transmitter node is connected to the controller 516. It should be understood that the connection of each transmitter node to the controller 516 could be enacted by connecting the transmitter nodes to each other, e.g. chained together by respective connections or connected in series, where only one of the transmitter nodes is then connected directly to the controller 516; or by connecting each transmitter to the controller 516 via individual separate connections, as shown in FIG. 5; or by any combination of the two. Alternatively or additionally, there may be a switch (not shown), through which the controller 516 is connected to each transmitter node 503, 507. As a result of the switch, the controller may be connected to and subsequently able to control any one, or any combination, of the plurality of transmitter nodes 503, 507.

In embodiments the controller 516 may be located externally to the at least two transmitter nodes 503, 507 and connected thereto, as shown in FIG. 5. E.g. the controller may be implemented in a dedicated control unit or on a server. In another alternative the controller 516 could be a distributed function distributed through some or all of the transmitter nodes 503, 507, or any combination of the above approaches. Wherever implemented, the controller 516 may be implemented in the form of software stored in memory comprising one or more memory units employing one or more memory media (e.g. electronic memory such as an SSD, flash memory or EEPROM or magnetic memory such as a magnetic disk drive) and arranged to run on processing apparatus comprising one or more processing units (e.g. CPUs, GPUs, and/or application specific processors). Alternatively the controller 516 could be implemented in dedicated hardware circuitry, or configurable or reconfigurable circuitry such as a PGA or FPGA, or any combination of hardware and software.

This feedback signal(s) 514a, 514b may be an infrared signal or a radio frequency signal directed generally towards the transmitter node 503, 507 (e.g. within a range of angles which would be visible at the location of a transmitter node. For example, on a ceiling). The feedback signal(s) 514a, 514b may be used to negotiate the handover process between the access points of the optical wireless communication network. That is, receiving a feedback signal at a transmitter node may trigger the preparation of the handover, e.g. the receiver device may transmit the feedback signal upon detecting the data signal of the corresponding access point and indicating that the receiver device is now within the light cell of that access point and has the ability to in turn receive data from that access point. The controller may then make a decision as to which handover process to execute. This is particularly important when the number of access points detected by the receiver device is more than two. The receiver device may also transmit a feedback signal 514a, 514b to the controller comprising data signal amplitudes or pilot signal amplitudes. The relative amplitudes of the respective signal is used to determine whether certain criteria for preparation and execution of the handover have been fulfilled.

The controller 516 may determine which handover process to prepare and execute (e.g. which two access points the handover should be between), based on various items of information. The feedback signal 514a, 514b may include information on the motion or direction of travel of the receiver device. The controller may then use this information to determine which access point will be the next access point most likely to be used by the receiver device. Alternatively or additionally, the controller may determine which access points to perform the handover between based on data signal amplitude information fed back from the receiver device in the feedback signal 514a, 514b. The controller may also use information about the system 500 itself. For example the controller may have access to information about the location and relative positioning of the access points of the optical wireless communication network. This information may be stored locally at the controller, at a dedicated storage of the system, distributed throughout the elements of the system (e.g. each access point may have information about its own location etc.), or retrieved from a remote storage location via a network the controller is connected to (e.g. the internet).

Alternatively or additionally, a beacon type signal may be transmitted omni-directionally by the receiver device such that any transmitter node 503, 507 within range of the beacon signal may receive information for the purposes of instigating a handover between access points and light cells of the optical wireless communications network.

The system as describe in FIG. 5 provides two or more light cells where the signal distribution of each light cell is shaped such that in an overlapping region between the light cells of the neighboring LiFi access points enables: enough time to anticipate and prepare for handover, enough time to execute handover, and enough signal for optimal performance during handover.

The inventors have realized that there is a need to provide a system which achieves at least both a good performance level during the handover, but also to provide enough time for executing the handover after the handover trigger criterion is detected and before the data signal of the first access point is lost.

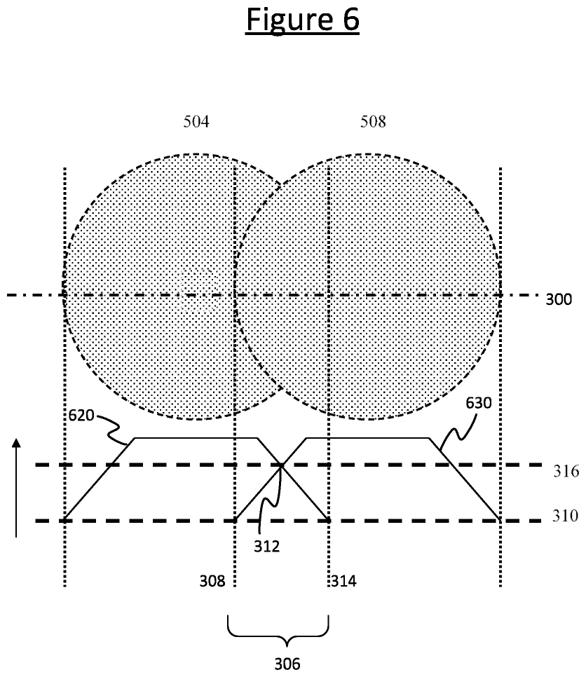

As, shown in FIG. 6, the above properties are provided by a system comprising at least two light cells 504, 508 which include respective data signals. The light cells 504, 508 are the coverage areas of the data signals of individual access points of a common optical wireless communication network 512. The light cells 504, 508 may be themselves provided by one or more light sources of the nodes of the access points. The signal distribution of each light cell has an amplitude profile 620, 630. The amplitude profiles 620, 630 determine the positioning of certain trigger points when the light cells 504, 508 of the access points overlap to form an overlapping region 306. These trigger points are used as criteria for executing a handover between the access points. The overlapping region 306 comprises these trigger points. The detection of the leading edge of the overlapping region 308 may be used to trigger preparation for a handover process. The detection of a crossing point 312 in the overlapping region may be used to trigger the execution of the handover process. The detection of the trigger points and thus the fulfilment of the respective criterion may be determined by the receiver device. The receiver device may communicate with the access points directly in response to detecting these criteria. As such detection of specific light cell edges 308, 314 and respective amplitudes 312 may cause preparation of the handover process or execution of the handover process.

FIG. 6 shows how the amplitude profile of the signal distribution in the overlapping area varies to allow a LiFi receiver device that moves from light cell 504 to light cell 508 to detect certain changes in data signal amplitudes at certain times, e.g. the presence of the data signal of light cell 508 when it enters the overlapping area. This may trigger the preparation of a handover to light cell 508. Additionally or alternatively, the amplitude profile of the signal distribution may allow the receiver to detect an increase in amplitude of the data signal of light cell 508 while moving forward (e.g. along line 300 from left to right) which may also trigger preparation of the handover. Here the receiver does not initially detect a decrease in amplitude of the data signal of light cell 504 as the amplitude of light cell 504 is constant at, and immediately after, line 308.

FIG. 6 also shows how the amplitude profiles 620 630 of the signal distributions within the overlapping region vary. These shape amplitude profiles allow the trigger for the execution of the handover process to be positioned roughly midway through the overlapping region 306. For example, the trigger may be the criteria of detecting a decrease in the amplitude of the data signal of light cell 504, detecting of the data signal of light cell 508 having a larger amplitude than that of light cell 508, or both.

Further, the performance in the overlapping region can be seen to be optimally above the threshold indicated by dashed line 316. In FIG. 6 this is the case at least until the trigger for the execution of the handover. However, the performance is sub-optimal after the trigger (e.g. the crossing point 312) because the signal of light cell 504 then drops below the threshold level 316 for optimal performance. Optionally the performance may remain above the threshold 316 after such a trigger criteria 312 is fulfilled by having an overall increased amplitude of the data signal (thus leading to the crossing point 312 occurring at a distance above the threshold 316), or similarly by reducing the upper threshold line 316. Thus the crossing point 312 may be positioned above the threshold 316 such that the handover may be triggered and executed before the amplitude of the data signal falls to the level of line 316 or below.

It may be necessary to keep the maximum amplitude of the data signal below a particular value for the sake of reducing power consumption and maintaining efficiency. The light sources used to emit the beams of light may have a maximum power output they are capable of providing. As such there may be a maximum of the central plateau of the amplitude profile, which in turn may impose a limit on the power efficiency. For example, the receiver may not be able to make use of the extra bandwidth provided, and as such the provision of a higher amplitude may be a waste of power and thus not be energy efficient.

The LiFi receiver device may differentiate between the received data signals of the LiFi light cells (and thus respective access points) using a property of the data signal. This property of the different data signals of the different light cells may be a different signal wavelength, a different signal modulation frequency, a different symbol in the pre-amble of the data signal, or a different LiFi identifier. Any combination of these properties may also be used to distinguish the two or more data signals of the respective light cells from each other.

The LiFi identifier could be carried in e.g. the header of the frame following the pre-amble, or in the rest of the frame following the header, the LiFi identifier could be part of the physical layer (PHY layer) or medium access layer (MAC layer).

The primary use of a specific or different pre-amble is to let the receiver focus on the reception of a single signal. That is, to improve the speed and to be less vulnerable to receiving other signals, which would then have a different pre-amble. If an end-point device (or receiver device, or client device) is associated with an access point (or transmitter node), it may use a dedicated pre-amble for high speed data transfer with that access point. This dedicated pre-amble is exchanged during the association process between the access point and end-point device. Therefore the end-point device may not be able to use the dedicated pre-amble of a neighboring access point for decoding the frame that follows the pre-able because the end-point device is not associated to that neighboring access point. However, the end-point may be able to detect that the pre-amble used by a neighboring access point is a different dedicated pre-amble than that used by the access point to which the end-point is associated.

Non-specific pre-ambles can be applied for management or control frames, for example, for use during association to an access point. In that case an end-point cannot distinguish which access point the pre-amble has come from. An identifier (e.g. a different LiFi identifier), within the frame itself (e.g. carried in the header of the frame), can then be used to provide the differentiation between signals received from different access points.

A light cell with the required amplitude profile of the signal distribution can be created using freeform optics. Freeform optics is a type of optics which comprises single optical elements which are manufactured to have a shape which produces the final desired optical distribution using only that single optical element. That is to say the single block of light manipulating medium is formed into a shape which directs the light that passes through it into the desired focal area. It should be understood that this single optical element may then be combined with other optical elements, e.g. such as to scale the obtained distribution, but such freeform optical elements may not require these further items. Freeform optics allows for custom optical elements to be formed to create the type of dispersion shapes and patterns required for the present invention. It should be understood that the described amplitude profiles of light cells needed for the present invention may also be created using reflectors, and other, non-freeform optics.

Alternatively, the shape may be provided by beamforming with an array of optical elements. The optical elements controlled to vary their amplitude or phase to achieve the desired output.

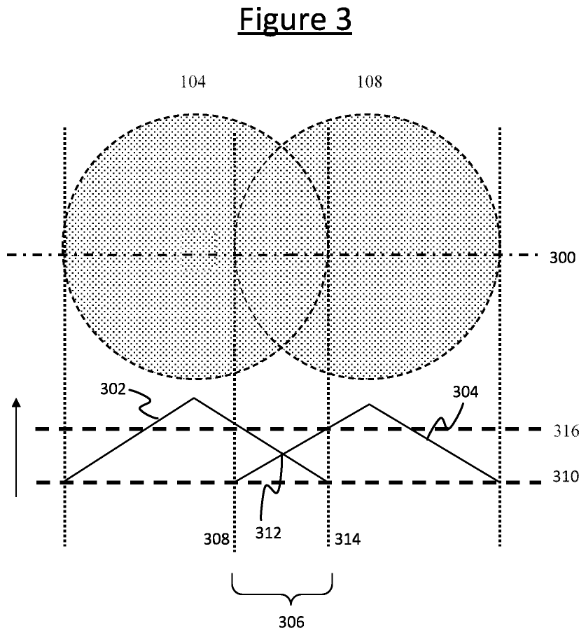

In previous systems such as those shown in FIG. 3, the shape of the amplitude profile of optical data signals has been limited to those of a Gaussian distribution or bell-curve. However, with improvements in optics manufacturing techniques the ability to shape optics in a free form way has allowed for freeform optics to be created, enabling the creation of the kind of optics which are able to create the single amplitude profile shape described herein. It should be understood that the amplitude profile shapes in FIG. 6 are simplified or idealized representations of the desired shapes. The signal footprint shape and therefore the amplitude profile shape can be tailored to the LiFi cell shape, such that the amplitude profile shapes can be implemented throughout the LiFi cell. The amplitude profile shape and trigger points (or trigger lines in a two-dimensional LiFi cell representation) can be tailored using freeform optics to the shape of the LiFi cell, regardless as to whether the LiFi cell is a square, a rectangle or a hexagon and thereby realizing the amplitude profile shape along the LiFi cell boundary. In practice there may be minor variations resulting in a slightly differently shaped profile, though without negating the ability of the light cells of the system to overlap and create the required trigger points at the desired locations.

In the above described example it is desired that the amplitude profiles 620, 630 of the respective data signals of the light cells are maintained above the amplitude indicated by line 316 to achieve the desired performance during the handover. Therefore the particular shape in the central region of the light cell is not necessarily exactly flat as shown in FIG. 6. That is to say a “plateau” as referred to herein does not necessarily imply a perfectly flat level, but rather the important feature is to maintain the desired performance above the threshold 316. The amplitude in the central region of each of the light cells may therefore not be completely flat, and may for example have somewhat of a drop off similar to that of the amplitude profile in FIG. 3. For example, the drop off may slope to a lesser extent than that shown in FIG. 3, but to a greater extent than the central region of the amplitude profile of the data signal in FIG. 6 (e.g. not completely flat). However, it should be recognized that although the central region does not have to be flat, the optical power and required emitted photons over the central region of the light cell is most efficient with an approximately flat central amplitude profile. This is because providing much more power does not provide a linearly equivalent higher speed signal or more data bandwidth. These are limitations of the optical wireless communications system which cannot be changed by simply increasing the brightness of the emitted optical signal. Also given the available optical power (or emitted photons), a higher amplitude at a certain part of the central region will be at the cost of the amplitude at other regions (e.g. the edges of the light cell) and may compromise the required amplitude of these other regions. Thus the available optical power is (or emitted photons are), most efficiently distributed when the amplitude profile of the majority of the light cell, for example the central region as depicted in FIG. 6, is approximately flat. Such an efficient distribution also allows for the required optical power to be minimized. I.e. this allows for there to be enough signal at any part of the light cell with a minimum total amount of power being used.

It should also be appreciated that the term slope is intended to describe a region of the light cell where the signal amplitude profile transitions between a higher level and a lower level, either with a positive gradient or a negative gradient. The term slope is not intended to imply a completely straight line amplitude profile exists between these points but an approximation thereto only. Depiction of the slopes as straight lines in the figures is merely illustrative of such an approximation. For example, the amplitude profile slope may be implemented through optical elements arranged and designed to create such a slope, through drop off as a result of the inverse square law given a specific maximum amplitude to create the desired slope, or a combination of the two.

In an embodiment of the present invention the above objectives are achieved using two signals instead of one. In this embodiment there is provided two distinct signals, the LiFi data signal and a pilot signal. The pilot signal is used to provide the trigger points for the handover process with optimal positioning, but does not provide the main data signal for the optical wireless communication network. A LiFi data signal is provided for the transfer of data, but the handover process is not triggered by detection of this signal or signals of this type.

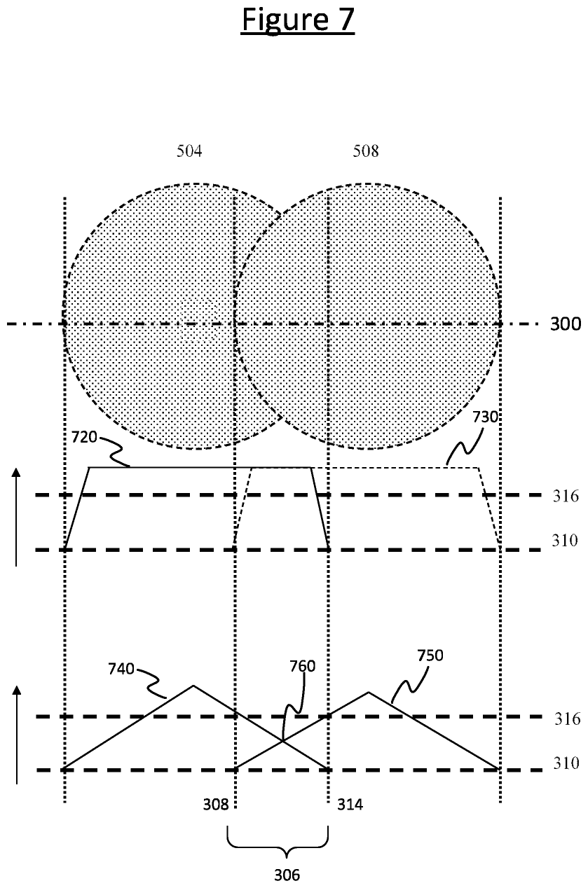

FIG. 7 shows the system of the embodiment with amplitude profiles 720, 730, 740, 750 of the two types of signals (data and pilot) along the cross section line 300.

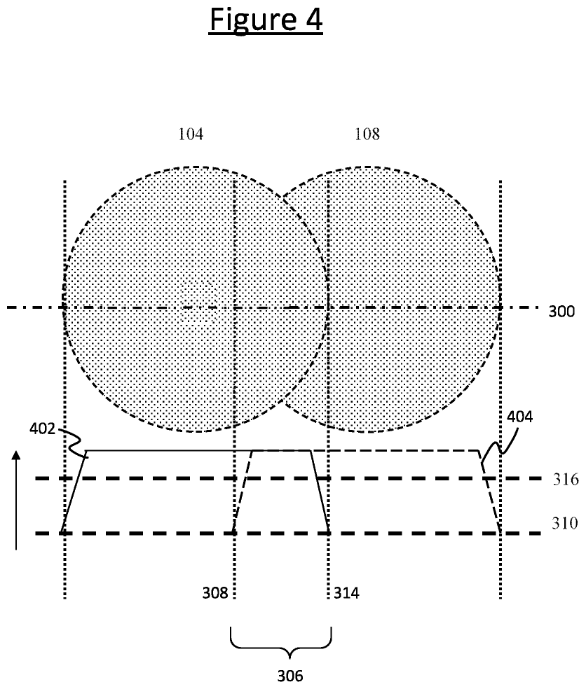

The amplitude profile of the LiFi data signal may have a similar shape to that of the data signal described in reference to FIG. 4. The amplitude profile 720 730 may have steep edges and a central plateau as shown in FIG. 7. A signal distribution with this shape amplitude profile allows for an optimal performance of the LiFi network throughout the overlapping region, provided by either one or both of the neighboring light cells 504 and 508. However, it should be realized that this amplitude profile shape of the data signal is not required, and that the important aspect of the amplitude profile of the data signal is that the amplitude is above the pre-determined threshold level 316 throughout the overlapping region of the respective data signals of the light cells.

In embodiments where the amplitude profile of the respective data signals are similar to that shown in FIG. 7, the overlapping region may be constructed such that there exists an ascending edge comprising the ascending edge of one light cell data signal, a plateau comprising the plateau of both light cell data signals, and a descending edge comprising the descending edge of the other light cell data signal.

The pilot signal of each respective access point may be aligned with the LiFi data signal of the same respective access point. As such the limits of the coverage area of the data signal may also be the limits of the coverage area of the pilot signal for a single access point. The amplitude profile of the pilot signal may therefore allow a LiFi receiver moving from light cell 504 to light cell 508 to detect the presence of the second access point with light cell 508 when it enters the overlapping region. This is instead of using the detection of the LiFi data signal. Thus the overlapping region in this case corresponds to the overlapping region of both the data signal and the pilot signal. The pilot signal can therefore be used to trigger the preparation of the handover between the light cells 504 and 508.

The pilot signal itself has an amplitude profile with a shape similar to that of the data signal described in reference to FIG. 3. This may be the same as the amplitude profile resulting from the inverse square law drop off of an optical signal. The pilot signal may therefore be used to trigger the execution of the handover in a similar way to that described above for the data signal in reference to FIG. 6, as the crossing point 760 is optimally positioned roughly in the middle of the overlapping region. Alternatively or additionally, the detection of a decrease in amplitude of the pilot signal of light cell 504 and an increase in amplitude of the pilot signal of light cell 508 may be used to trigger the preparation of the handover. The detection of the change in signal amplitude is performed by the receiver device, and the triggering may involve transmitting signals from the receiver device to the respective access points in order to instigate the handover process.

The pilot signal is thus described as having a signal distribution with an amplitude profile which comprises an ascending edge and a descending edge. The respective pilot signals of neighboring access points overlap to form an overlapping region. The overlapping region has an amplitude profile which comprises an ascending edge comprising the ascending edge of one pilot signal and a descending edge comprising the descending edge of another pilot signal. The amplitude profiles of the overlapping pilot signals cross on an ascending edge of one pilot signal and the descending edge of the other pilot signal to form an apex of the overlapping region.

The apex of the overlapping region, where the two neighboring pilot signals overlap, provides the trigger for handover execution. This where the pilot signal of light cell 508 is detected as having a higher amplitude than that of light cell 504. A further decrease of the amplitude of the pilot signal of light cell 504 and an increase in the amplitude of the pilot signal of light cell 508 can also additionally or alternatively trigger the execution of the handover. By triggering the handover using the separate pilot signal, the condition for triggering execution of the handover is optimally achieved at a position in the middle of the overlapping regions (of the pilot signal and the data signal), and thus the system is provided with enough time to execute the handover. Although FIG. 7 shows the amplitude of the crossing point 760 as occurring at an amplitude of the threshold 316, it should be noted that the level of the pilot signal crossing point may be significantly lower than the threshold of the data signal for the desired performance. This is because the pilot signal itself is not being used to transmit high speed data and thus the desired performance threshold 316 for the data signal may not apply to the pilot signal. For example, it may be sufficient that the respective pilot signals of the light cells are simply determined to be detected with respective amplitudes in order for the handover process to be triggered. Hence a lower signal amplitude for the pilot signal may be adequate.

In embodiments the pilot signal of an access point may have a larger footprint than its respective data signal. This may allow a receiver moving between access points even notice of a nearby access point and thus more time for preparing a handover. This is possible as the pilot signal is not limited to the boundaries of the data signal. The required greater amount of overlap would not be efficient if using only a single data signal to provide data and trigger handover as a significant amount of power would be used to provide the data signal by two different access points covering much of the same area. That is, the same areas would be provided with coverage by a data signal of high power in order to provide only greater amount of forewarning of a handover, and would not increase the data transfer as a result.

In embodiments the pilot signal may have a footprint or coverage area which extends beyond the data signal of the neighboring access point. This can help to determine more accurately the correct handover to execute based on a more accurate estimate of the direction of travel of the receiver device. For example, a triangulation method could be used to determine the location of a moving receiver. A wider footprint of the pilot signal may thus help in the case of multiple transmitter nodes e.g. in an open office space.

In embodiments, the pilot signal may be a low frequency signal. That is, the pilot signal need only be of sufficient power to be detected, and to be determined as increasing or decreasing in amplitude compared to another pilot signal. It is therefore a more efficient use of this shape signal to provide a low frequency pilot signal than a data signal, e.g. compared to the system described in reference to FIG. 3. This is because the central peak of this Gaussian curve need not be excessively high powered to obtain the necessary amplitude for optimal data transfer at the edges. Also for this same reason it is possible to extend the range of the pilot signal beyond the range of the data signal of the respective access point while still being power efficient.

In embodiments, the pilot signal being a low frequency signal may allow for the use of low-cost components for generating and detecting this signal. Therefore increasing the coverage area of the pilot signal in this case would not increase the power requirements, for example to the same extent that an increase in the coverage are of the data signal would. For example, the data signal may have a frequency above two megahertz, and the pilot signal may have a frequency below two megahertz. The ‘low’ and ‘high’ frequency boundary need not be limited to two megahertz. The data and pilot signal frequency ranges could be any separate frequency ranges. The criteria for the frequency ranges is that the chosen ranges allow the data signal and pilot signal to be used without interfering with each other. That is to say the frequency range of the one or more pilot signals and the frequency range of the one or more data signals should not overlap.

Again, it should be appreciated that the term slope is intended to describe a region of the light cell where the signal amplitude profile transitions between a higher level and a lower level, either with a positive gradient or a negative gradient. The term slope is not intended to imply a completely straight line amplitude profile exists between these points but an approximation thereto only. Depiction of the slopes as straight lines in the figures is merely illustrative of such an approximation. For example, the amplitude profile slope may be implemented through optical elements arranged and designed to create such a slope, through drop off as a result of the inverse square law given a specific maximum amplitude to create the desired slope, or a combination of the two.

In embodiments, the LiFi receiver device may differentiate between the received data signals of the LiFi light cells as described above. Similarly, the LiFi receiver device may differentiate between the received pilot signals of the LiFi light cells (and thus respective access points) using a property of the pilot signal. This property of the different pilot signals of the different light cells may be a different signal wavelength, a different signal modulation frequency, a different symbol in the pre-amble of the pilot signal, or a different LiFi identifier. When using pilot signals with different wavelengths the pilot signals may be DC signals, or direct current signals, by which it is meant that the signal may not contain modulations for encoding data. In embodiments, the modulation frequency could be regarded as the carrier frequency on which data signals can be modulated. DC in that sense, means that the pilot signal has no carrier frequency. In principle there can still be data modulated on a DC signal, but also that is not needed if the wavelengths differ.

In both embodiments described above in relation FIGS. 6 and 7, the shape of the footprint of the light cell may not be circular. For example, the light cell footprint may be shaped (e.g. using reflectors, freeform optical elements, or non-freeform optics), into any entirely or partially tessellating polygon. That is to say, any shape which allows an area to be covered, with some overlap, can be used to form the footprint shape of the data signals. Similarly, these criteria may be adhered to when choosing the shape of the footprint of the pilot signal of the second embodiment. Example shapes which could be used as a signal footprint shape are a square, a circle, a hexagon, a rectangle, a pentagon, or for a plurality of light cells any combination thereof.

Further disclosed is a system (500) according to this clause 1, the system comprising at least two light cells (504, 508), the light cells connected to form a light communication network where each light cell provides an access point (502, 506) of the light communication network, the system comprising: at least two light cells (504, 508) each formed by emitted beams of light comprising a signal, where the signal distribution has an amplitude profile (620, 630) which comprises an ascending slope, a plateau, and a descending slope, the at least two light cells overlapping to form an overlapping region (306) with at least one edge where one of the two signals has an amplitude of the plateau whilst overlapping with the other of the two signals, and a crossing point (312) where the ascending slope of one signal crosses the descending slope of the other signal, thereby enabling triggering of a handover process of a receiver device from one light cell to the other light cell in response to being detected by a receiver device.

Also disclosed, is a system according to this clause 2, which corresponds to the system according to clause 1, the system comprising: the receiver device (510) configured to detect at least two signals in the form of emitted beams of light, the at least two signals indicating that the receiver device is located within at least two respective light cells which provide at least two access points of a light communication network, and upon detection of the edge of the overlapping region (308, 314), or the crossing point of the overlapping region (312), trigger a pre-handover process or a handover process respectively.

Also disclosed, is a system according to this clause 3, which corresponds to the system according to any one of clauses 1 to 2, wherein the beam of light is emitted through an optical element comprising one or more of a freeform optical element, a lens optical element, and a reflector optical element,

Also disclosed, is a system according to this clause 4, which corresponds to the system according to any one of the clauses 1 to 3, wherein the source of the beam of light is a single LED or an array of LEDs.

Also disclosed, is a system according to this clause 5, which corresponds to the system according to any one of clauses 1 to 4, wherein the source of the beam of light is a single LED behind a single freeform optical element or an array of LEDs behind a single freeform optical element.

Also disclosed, is a system according to this clause 6, which corresponds to the system according to any one of clauses 1 to 5, wherein the signals of the at least two light cells (504, 508) are differentiable from each other.

Also disclosed, is a system according to this clause 7, which corresponds to the system according to clause 6, wherein the signals are differentiable from each other by each signal of each light cell having a different signal wavelength.

Also disclosed, is a system according to this clause 8, which corresponds to the system according to clause 6, wherein the signals are differentiable from each other by each signal of each light cell having a different signal modulation frequency.

Also disclosed, is a system according to this clause 9, which corresponds to the system according to clause 6, wherein the signals are differentiable from each other by each signal of each light cell having a different symbol in the pre-amble of the data signal, or a different LiFi identifier.

Also disclosed is a method according to this clause 10, corresponding to a method of performing at a receiver device (510) a handover between at least two light cells (504, 508) each comprising a signal, the light cells connected to form a light communication network where each light cell provides an access point (502, 506) of the light communication network, the method comprising: detecting an edge (308, 314) of an overlapping region (306) of the at least two light cells, or detecting a crossing point (312) in an overlapping region (306) of the at least two light cells where an ascending slope of the signal of one light cell crosses a descending slope of the signal of the other light cell; in response to said detecting the edge, performing a pre-handover process in anticipation of the receiver device moving from one light cell to the other light cell; and in response to said detecting the crossing point, triggering a handover process of the receiver device from one light cell to the other light cell.

It will be appreciated that the above embodiments have been described only by way of example. Other variations to the disclosed embodiments can be understood and effected by those skilled in the art in practicing the claimed invention, from a study of the drawings, the disclosure, and the appended claims.

In the claims, the word “comprising” does not exclude other elements or steps, and the indefinite article “a” or “an” does not exclude a plurality. A single processor or other unit may fulfil the functions of several items recited in the claims. The mere fact that certain measures are recited in mutually different dependent claims does not indicate that a combination of these measures cannot be used to advantage. A computer program may be stored and/or distributed on a suitable medium, such as an optical storage medium or a solid-state medium supplied together with or as part of other hardware, but may also be distributed in other forms, such as via the Internet or other wired or wireless telecommunication systems. Any reference signs in the claims should not be construed as limiting the scope.

1. A system comprising at least two light cells, the light cells connected to form a light communication network where each light cell provides an access point of the light communication network, wherein the system comprises:
at least two light cells each formed by a respective first beam of light comprising a respective data signal,
where each data signal has an amplitude profile at a predetermined height with a portion above a pre-determined threshold level, and said portion of the respective data signals of the at least two light cells partially overlap to form an overlapping region with an amplitude profile above the pre-determined threshold level,
the at least two lights cells each are further formed by a second beam of light comprising a pilot signal, and
each pilot signal has an amplitude profile at the predetermined height which comprises an ascending edge and a descending edge and a footprint which is aligned with a footprint of the respective data signal, the respective pilot signals of the at least two light cells overlapping to form an overlapping region with an amplitude profile which comprises an ascending edge comprising the ascending edge of one pilot signal and a descending edge comprising the descending edge of the other pilot signal and with a footprint which is aligned with a footprint of the of the overlapping region of the data signals and a crossing point where the ascending edge of one pilot signal crosses the descending edge of the other pilot signal.

2. The system according to claim 1, the system comprising:
a receiver device configured to detect one or more data signals in the form of emitted beams of light and at least two pilot signals, the at least two pilot signals indicating that the receiver device is located in a proximity of at least two respective light cells which provide at least two access points of a light communication network, and upon detection of an edge of the pilot signal overlapping region, or the crossing point of the pilot signal overlapping region (760), trigger a pre-handover process or a handover process respectively.

3. The system according to claim 1, wherein the pilot signal is a lower frequency signal than the data signal.

4. The system according to claim 1, wherein the data signal has a frequency above two megahertz, and/or the pilot signal has a frequency below two megahertz.

5. The system according to claim 1, wherein the pilot signals of the at least two light cells are differentiable from each other.

6. The system according to claim 5, wherein the pilot signals of the at least two light cells are differentiable from each other by one or more of a different signal wavelength, a different signal modulation frequency, a different symbol in a pre-amble of the signal, or a different LiFi identifier.

7. The system according to claim 1, wherein the beam of light providing the pilot signal and/or the data signal is emitted through one or more optical elements comprising a freeform optical element, a lens optical element, or a reflector optical element.

8. The system according to claim 1, wherein the source of the beam of light providing the pilot signal and/or the data signal is a single LED or an array of LEDs.

9. A receiver device for use in the system according to claim 1, the receiver device configured to:
detect one or more data signals from the at least two light cells using a light sensor,
detect at least two pilot signals of the at least two light cells, the two pilot signals indicating that the receiver device is located in a proximity of the at least two respective light cells provided by the at least two access points of a light communication network; and
detect an edge of an overlapping region of the at least two pilot signals of the light cells, and in response to said detection of the edge, perform a pre-handover process in anticipation of the receiver device moving from one light cell to the other light cell; or
detect a crossing point of an overlapping region of the at least two pilot signals of the light cells where the ascending slope of the pilot signal of one light cell crosses the descending slope of the pilot signal of the other light cell, and in response to said detection of the crossing point, triggering a handover process of the receiver device where the receiver device transfers from the data signal of one light cell to the data signal of the other light cell.

10. A method of performing at a receiver device a handover between at least two light cells comprising a pilot signal and a data signal, the light cells connected to form an optical wireless communication network where each light cell provides an access point of the optical wireless communication network, and the at least two light cells each further comprise a respective pilot signal, the method comprising:
detecting an edge of an overlapping region of the at least two pilot signals of the light cells, or
detecting a crossing point of an overlapping region of the at least two pilot signals of the light cells where the ascending slope of the pilot signal of one light cell crosses the descending slope of the pilot signal of the other light cell; and
in response to said detecting the edge, performing a pre-handover process in anticipation of the receiver device moving from one light cell to the other light cell; or
in response to said detecting the crossing point, triggering a handover process of the receiver device where the receiver device transfers from the data signal of one light cell to the data signal of the other light cell.

11. A computer program product comprising instructions to cause the receiver device of claim 9.

12. A non-transitory computer-readable medium storing instructions when executed by one or more processors cause the one or more processors to perform the method of claim 10.
